(19) United States
(12) Patent Application Publication
(10) Pub. No.: US 2024/0251013 A1
(43) Pub. Date: Jul. 25, 2024

(54) Method and System for Dense Radiation Mapping Using Only a Small Number of Sensors

(71) Applicant: Applied Research, LLC, Rockville, MD (US)

(72) Inventor: CHIMAN KWAN, ROCKVILLE, MD (US)

(21) Appl. No.: 18/099,655

(22) Filed: Jan. 20, 2023

(51) Int. Cl. H04L 67/12; G01T 1/29

(52) U.S. Cl. CPC H04L 67/12; G01T 1/2921; H04W 84/18

(57) ABSTRACT

The present invention describes a dense radiation map generation system using radiation detection sensors with advanced signal processing algorithms. Only a small number of detectors is needed, and yet dense radiation maps can be generated via signal processing algorithms. The detectors are wirelessly connected to a data processing center. The present invention utilizes an integrated system for dense radiation map generation, making it feasible to low cost and real-time radiation monitoring.

### ORIGIN OF THE INVENTION

This invention was made with Government support under contract DE-SC0021804 awarded by the Dept. of Energy (DOE). The Government has certain rights in this invention.

### BACKGROUND OF THE INVENTION

Radiation hazards exist in facilities such as nuclear power plants, particle accelerators, etc. Safety of personnel in a facility and neighboring communities is highly important. Monitoring the radiation levels in these facilities can be costly and labor intensive. It is costly because many expensive radiation detectors are needed in order to cover large areas. It is labor intensive because human operators are needed to collect and interpret the radiation data. The present invention describes a dense radiation map generation system using radiation detection sensors with advanced signal processing algorithms. Only a small number of detectors is needed, and yet dense radiation maps can be generated via signal processing algorithms. The detectors are wirelessly connected to a data processing center. The present invention utilizes an integrated system for dense radiation map generation, making it feasible to low cost and real-time radiation monitoring.

### BRIEF SUMMARY OF THE INVENTION

One embodiment of the present invention is to provide a method and system to carry out radiation detection in a facility using gamma and neutron detectors.

Another embodiment of the present invention involves the use of a wireless sensor network to connect the radiation detectors with the data processing center.

Another embodiment of the present invention is to use a central data processing center to collect, save, and process the radiation sensor data.

Another embodiment of the present invention is to utilize advanced signal processing algorithms to generate dense radiation map of a facility based on a small number of sensors.

Another embodiment of the present invention is that the algorithms can be implemented in low-cost Digital Signal Processors (DSP), Field Programmable Gate Arrays (FPGA), Personal Computers (PCs), or Cloud Computing (CC) for real-time processing.

Another embodiment of the present invention is that a radiation map can be displayed in a monitor for operator to visualize.

### BRIEF DESCRIPTION OF THE DRAWINGS

FIGS. 1(a) & 1(b) illustrate a gamma detector and a neutron detector, respectively.

FIG. 2 illustrates a dense radiation map generation system for a nuclear facility.

FIG. 3 illustrates Radiation Boundary Monitors (RBM) real-time display for Jefferson National Laboratory.

FIGS. 4(a), (b) & (c) illustrate the distribution of radiation measurements where only 1% of the grid points are available. The number of measurements inside the rectangles are the same for the three cases, but the number of measurements outside the rectangles are different. In particular, (a), (b), (c) have 10, 50, 100 measurements outside the rectangles, respectively.

FIGS. 5(a), (b) & (c) illustrate the distribution of radiation measurements where only 0.5% of the grid points are available. The number of measurements inside the rectangles are the same for the three cases, but the number of measurements outside the rectangles are different. In particular, (a), (b), (c) have 10, 50, 100 measurements outside the rectangles, respectively.

FIG. 6 illustrates the dense radiation maps using the parametric approach with 99% missing data for the inverse distribution case.

FIG. 7 illustrates the dense radiation maps using the parametric approach with 99.5% missing data for the inverse distribution case.

FIG. 8 illustrates the dense radiation maps using the parametric approach with 99% missing data for the Gaussian distribution case.

FIG. 9 illustrates the dense radiation maps using the parametric approach with 99.5% missing data for the Gaussian distribution case.

### DETAILED DESCRIPTION OF THE INVENTION

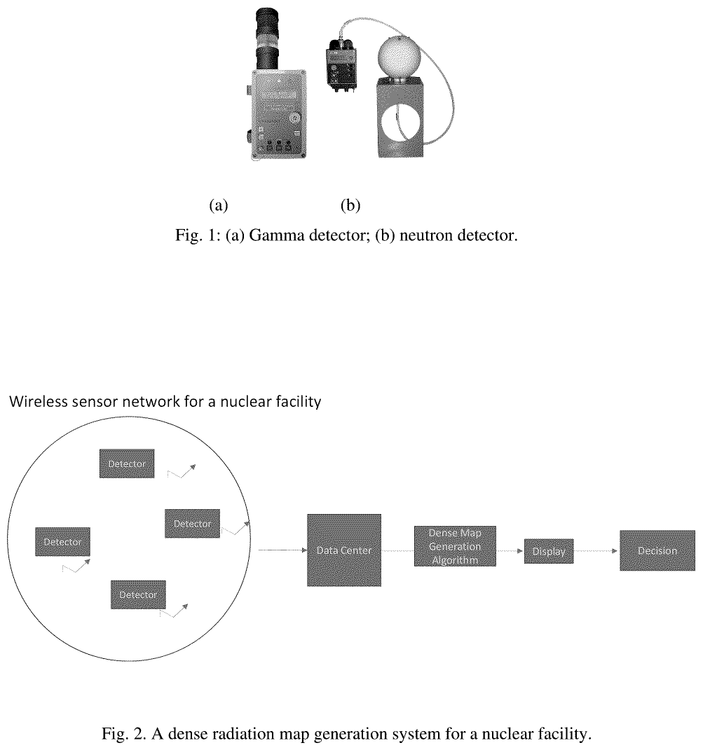

There are various types of detectors, including ionization chambers, silicon diode detectors, Helium 3 tubes, etc., for area monitoring. The G64 area gamma monitor [1] manufactured by Mirion Technologies is one representative detector. The NIM 201K monitor is a typical neutron detector for area monitoring [2]. Both sensors are shown in FIG. 1. Many detectors can be used by the radiation monitoring system. The above are just exemplar ones.

### Wireless Sensor Network

The radiation detectors are connected together via a wireless sensor network. There are different types of wireless sensor network. Zigbee is one popular type. Zigbee is low cost and efficient for collecting various radiation detector signals.

CC2430 TI System-on-Chip is used as the core for hardware nodes in the Zigbee network. The external circuit of CC2430 is very simple because of its powerful functions. It couples a PCB antenna, so the system is further enhanced power conservation.

The CC2430 is a true System-On-Chip for wireless sensor networking ZigBee™/IEEE802.15.4 solutions for 2.4 GHz wireless sensor network. It combines the excellent performance of the leading CC2420 RF transceiver with an industry-standard enhanced 8051 microcontroller (MCU), with 128 KB flash memory and 8 KB RAM. Both the embedded 8051 MCU and the radio components have very low power consumption. The CC2430 also includes 12-bit ADC (Analog-to-Digital Converter) with up to eight inputs and configurable resolution. Two powerful USARTs support several serial protocols. The CC2430 is one of the most competitive ZigBee solutions among industry when combined with the ZigBee protocol stack (Z-Stack) from TI.

### Proposed System for Dense Radiation Map Generation

FIG. 2 illustrates the key steps of a dense radiation map generation system. Radiation detectors are distributed in a facility such as a particle accelerator or a nuclear plant. The detectors are sparsely distributed in the facility, and they are connected with a wireless sensor network. The detectors periodically collect the radiation levels in the facility and the signals are wirelessly transmitted to the data center for storage and processing. Within the center, an algorithm in a PC or a DSP generates a dense radiation map of the facility. One key idea in the algorithm is a parametrized model which characterizes the radiation distribution. The model is flexible and can deal with multiple radiation sources in the facility. Based on the sparse sensor measurements, the algorithm can estimate the parameters in the model. Once the model is estimated, the dense map can then be generated. The map is then displayed in a monitor for human operator visualization and decision making.

### Signal Processing for Model Estimation

The present invention proposes a parametric approach to generate a radiation distribution function. The basic idea is to assume that the radiation magnitude distribution follows a Gaussian or inverse distribution with unknown model parameters. If there are multiple radiation sources, they will be simply summed up together.

For a Gaussian distribution with N radiation sources, the radiation map can be expressed as follows:

$$f ( x , y ) = {\sum }_{i = 1}^{N} {A}_{i} {e}^{- [ {( x - {x}_{i} )}^{2} + {( y - {y}_{i} )}^{2} ] / 2 {σ}_{i}^{2}} \qquad ( 1 )$$

where Aᵢ denotes the amplitude of the i^{th} source, (xᵢ, yᵢ) denotes the coordinates of the center of source i, σᵢ denotes the standard deviation of source i.

For the inverse distribution with N radiation sources, the radiation map is parametrized as:

$$f ( x , y ) = {\sum }_{i = 1}^{N} \frac{{A}_{i}}{\sqrt{[ {( x - {x}_{i} )}^{2} + {( y - {y}_{i} )}^{2} ]}} \qquad ( 2 )$$

where Aᵢ denotes the amplitude of the ith source, (xᵢ, yᵢ) denotes the coordinates of the center of source i.

In order to solve for those unknown parameters in the parametric models, a system of nonlinear equations where a number of known coordinates and their measured values into the equations is used. Then this system is fed into either some nonlinear function solvers, such as the Matlab functions fsolve or Isqnonlin. These functions will attempt to iterate until a solution meets the tolerance criteria set in the parameters.

The fsolve [4] uses two different algorithms depending on whether the system is square or non-square. A non-square system uses the Levenberg-Marquardt equation whereas the square system will use the trust-region-dogleg equation. In experiments of the present invention, a square system would only occur when the number of coordinates is equal to the number of signals*4 (each of the unknowns for an equation). So, in a simulated three-sources case, it would have a square system when 12 coordinates are used.

The Isqnonlin [3] does not make the same distinction between square and non-square systems. This function has an advantage over the fsolve because it allows the user to specify the lower and upper bounds of the unknowns in the system. This is quite useful in experiments because the location of the sensors in various halls is roughly known. By specifying the upper and lower bounds, one can set a bounding box around the general location to help the Isqnonlin function. When these nonlinear equations are solved, there are times where the solver will only find the local minima. By narrowing down the range of values, the solver will be able to find the global minima. In addition to narrowing the range of values, many iterations with some randomly initialized parameters are run, and cluster the results in order to eliminate any outlier solutions.

### Simulated Scenario

There are several ways to generate the mixed Gaussian or inverse radiation signals. For the Gaussian case, the Matlab function mvnpdf is used, which requires only the standard deviation and the center coordinate parameters. For the inverse distribution, the equation shown in Eq. (2) is used to generate the radiation distribution.

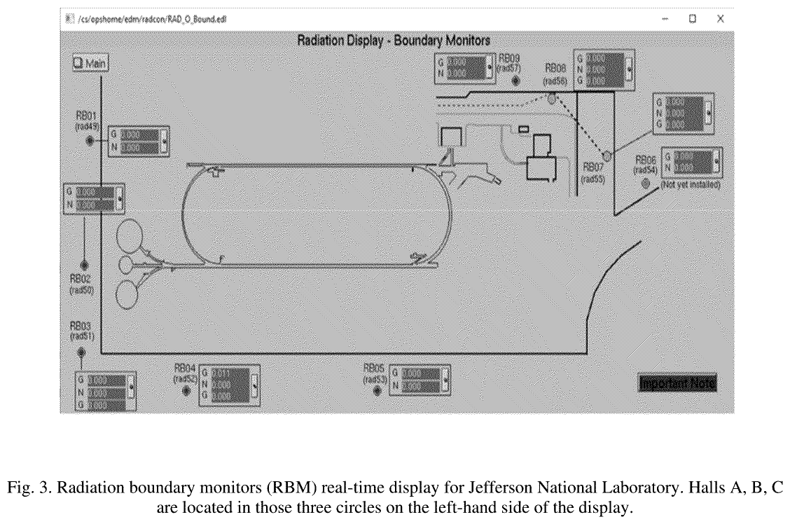

The simulated data were generated to resemble the Halls A, B, and C sensors at Jefferson Laboratory (Jlab). These sensors are located near those three circles in FIG. 3. So, the simulated data for both the Gaussian and inverse cases resemble the Jlab layout.

### Masks of the Available Sensor Measurements

Once the simulated data have been generated, a variety of masks are applied in an attempt to mimic the conditions of Jefferson Lab. Since there are only a handful of sensors located throughout the laboratory, the masks should only have a handful of known pixels. Each pixel represents one sensor measurement. There are two scenarios in the experiments.

In the first scenario, the image size was assumed to be 256×256, meaning that there are 65536 measurements. Each pixel represents one measurement. The first is using 99% missing pixels. That is, only 1% of the measurements are known and the rest 99% are unknown. Around the Halls A, B, C (white rectangle), there is no reduction of pixels. But in the background, which is outside the white rectangle, the pixel count is reduced to 100, 50, and 10. This is an attempt to understand how certain methods will perform with less and less knowledge about the pixels. The pixels in the background are also reduced because in the Jlab sensory layout, there are fewer boundary sensors than internal hall sensors.

In the second scenario, it is similar to the first, except now 99.5% missing pixels is used. The 99% mask has 21 known pixels (sensor measurements) within the white rectangle regions. The 99.5% mask has only 9 known pixels (sensor measurements) within the white rectangle. This value can be added to the number of background pixels to get the total amount of known pixels.

### Performance Metric

One performance metric is used throughout this study, and it is the Peak Signal to Noise Ratio (PSNR). To generate PSNR, the Root Mean Squared Error (RMSE) is needed. The RMSE of two vectorized images S (ground truth) and ŝ (prediction) is defined as:

$$R M S E ( S , \hat{S} ) = \sqrt{\frac{1}{Z} {\sum }_{j = 1}^{z} {( s - {\hat{s}}_{j} )}^{2}} \qquad ( 3 )$$

where Z is the number of pixels in each image. The ideal value of RMSE is 0 if the prediction is perfect. The PSNR is related to RMSE defined in Equation (3). If the image pixels are expressed in doubles with values between 0 and 1, then

$$P S N R = 20 log ( 1 / R M S E ( S , \hat{S} ) ) \qquad ( 4 )$$

A higher PSNR means better quality.

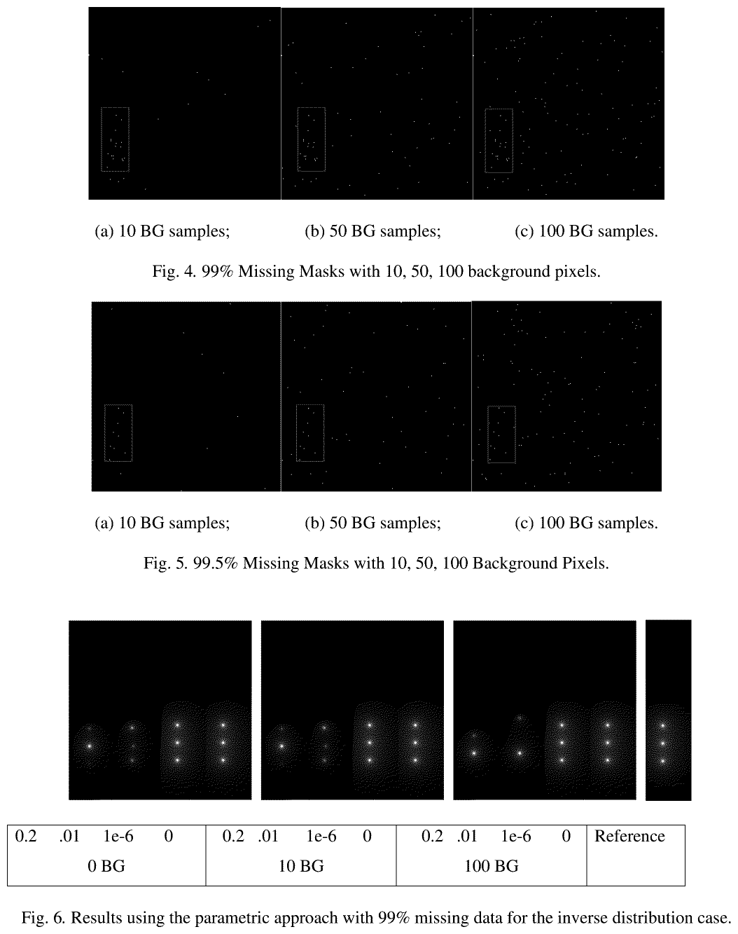

FIGS. 4-5 show two hypothetical sensor measurements over an accelerator facility (Jefferson Lab). In those rectangles, there are slightly more measurements close to the experimental areas. Outside the rectangles, there are fewer measurements. FIG. 4 shows the case where the density of the measurements is only 1% of the total number of grid points in the image. FIG. 5 shows the case where the density is even smaller (0.5% of the total grid points).

### Results Using the Parametric Method for the Inverse Distribution Case

Table 1, FIG. 6 and FIG. 7 summarize the inpainting results using the parametric approach for the inverse distribution case. The observations are as follows:
1) More BG samples do not help the inpainting performance in general. Actually, more BG samples make the estimation worse especially in the noisy cases;
2) Higher measurement noise degrades the performance. However, the results are still better than those supervised and unsupervised results in Sections 3.2.1 and 3.2.2;
3) Parametric approach is quite robust to the percentage of missing ratios;
4) Subjective visualization of the results shows good results up to noise variance of 0.01.

TABLE 1
PSNR values of the parametric approach: radiation follows an inverse distribution.

| | 99% Missing Data | | | 99.50% Missing Data | | |
|---|---|---|---|---|---|---|
| Parametric | (1% of sensor measurements are known) | | | (0.5% of sensors are known) | | |
| Background samples | 0 | 10 | 100 | 0 | 10 | 100 |
| 0.2 noise variance | 30.4518 | 30.1131 | 30.0467 | 31.0297 | 30.3068 | 29.7050 |
| 0.01 noise variance | 31.1080 | 30.9461 | 29.9925 | 32.2550 | 30.8923 | 30.5035 |
| 1.00E−06 noise variance | 108.7540 | 65.5633 | 73.5897 | 91.4132 | 59.6965 | 70.6820 |
| 0 noise | 275.0012 | 256.9151 | 264.6504 | 298.6297 | 237.8509 | 253.4644 |

### Results Using a Parametric Method for the Gaussian Distribution Case

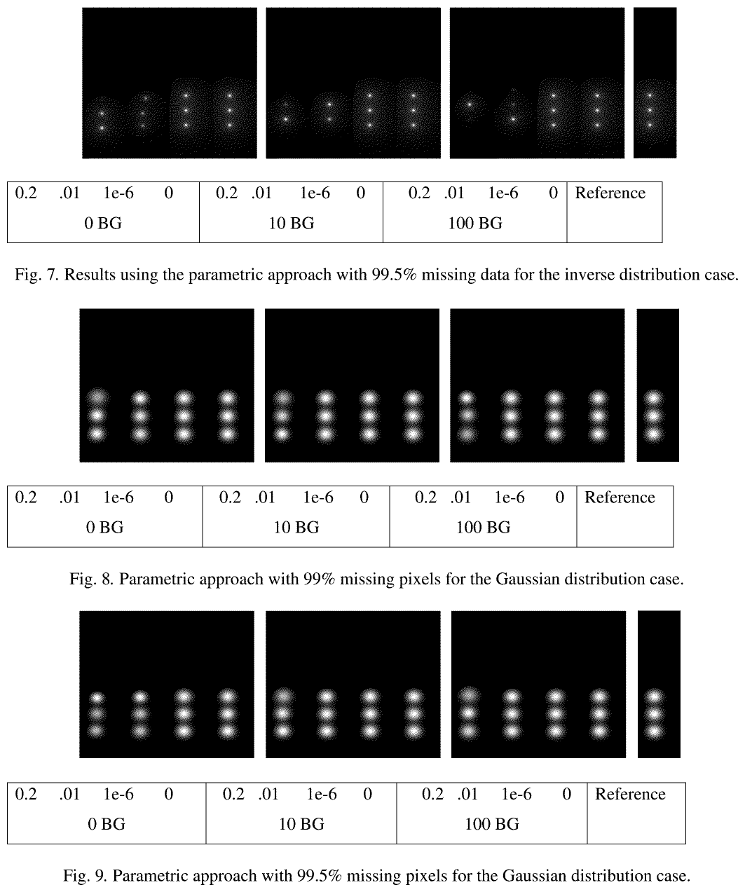

Table 2, FIG. 8 and FIG. 9 summarize the inpainting results using the parametric model approach. Here, the Isqnonlin function was used to estimate the model parameters. There are several observations:
1) More BG samples do not necessarily help the inpainting performance. Fewer appears to be better. This is because more noisy BG samples will create biased parameter estimates that will better match the noisy BG data;
2) Higher measurement noise degrades the performance;
3) Parametric approach is quite robust to the percentage of missing ratios;
4) Subjective visualization of the results show that the method generates very smooth predictions;
5) the PSNR values of the parametric approach are much better than Mumford-Shah and U-Net.

A word of caution should be mentioned. For the parametric approach to work, the model structure needs to be known. That is, the number of sources and the radiation decaying function need to be known. In the JLab case, the number of sources is known. The decaying function, however, needs to be determined experimentally, which will be done in the Phase 2.

TABLE 2
PSNR values of the parametric approach: radiation follows a Gaussian distribution.

| | 99% | | | 99.50% | | |
|---|---|---|---|---|---|---|
| Parametric | (1% of sensor measurements are known) | | | (0.5% of sensor measurements are known) | | |
| Background samples | 0 | 10 | 100 | 0 | 10 | 100 |
| 0.2 noise variance | 34.9898 | 34.8190 | 33.4155 | 38.1846 | 30.5318 | 34.8751 |
| 0.01 noise variance | 41.5469 | 64.9863 | 63.5603 | 60.3885 | 33.7839 | 55.1231 |
| 1.00E−06 noise variance | 68.7770 | 81.5084 | 75.2487 | 62.2972 | 55.5292 | 62.3009 |
| 0 noise | 86.1193 | 81.1129 | 75.2454 | 68.8813 | 62.4810 | 64.6226 |

It will be apparent to those skilled in the art that various modifications and variations can be made to the system and method of the present disclosure without departing from the scope or spirit of the disclosure. It should be perceived that the illustrated embodiments are only preferred examples of describing the invention and should not be taken as limiting the scope of the invention.

### REFERENCES

[1] https://www.mirion.com/products/g64-area-gamma-monitor
[2] https://www.mirion.com/products/nim-201k-neutron-irradiation-dose-rate-monitor
[3] Isqnonlin, https://www.mathworks.com/help/optim/ug/Isqnonlin.html.
[4] fsolve, https://www.mathworks.com/help/optim/ug/fsolve.html

What is claimed is:

1. A Dense Radiation Mapping (DRM) generation system comprising:
a central data processing center;
a wireless sensor network;
a set of radiation monitors for signals collection; and
said radiation monitors are connected to said central data processing center through said wireless sensor network for generating dense radiation map of a facility; and
a monitor for viewing said dense radiation map.

2. The DRM generation system of claim 1, wherein:
said radiation monitors include a gamma detector and a neuron detector.

3. The DRM generation system of claim 1, wherein:
said wireless sensor network is a Zigbee type for collecting said signals from said radiation monitors.

4. The DRM generation system of claim 1, wherein:
said central data processing center is a low-cost digital device.

5. The DRM generation system of claim 4, wherein:
said low-cost digital device is a Digital Signal Processor (DSP).

6. The DRM generation system of claim 4, wherein:
said low-cost digital device is a Field Programmable Gate Arrays (FPGA).

7. The DRM generation system of claim 4, wherein:
said low-cost digital device is a Personal Computer (PC).

8. The DRM generation system of claim 4, wherein:
said central data processing center is utilizing Cloud Computing (CC).

9. The DRM generation system of claim 1, wherein:
said dense radiation map is generated by said central data processing center using the following equation:
for a Gaussian distribution with N radiation sources,
$$f ( x , y ) = {\sum }_{i = 1}^{N} {A}_{i} {e}^{- [ {( x - {x}_{i} )}^{2} + {( y - {y}_{i} )}^{2} ] / 2 {σ}_{i}^{2}}$$
where N denotes a number, Aᵢ denotes the amplitude of the i^{th} source, (xᵢ, yᵢ) denotes the coordinates of the center of source i, σᵢ denotes the standard deviation of source i.

10. The DRM generation system of claim 1, wherein:
said dense radiation map is generated by said central data processing center using the following equation:
for the inverse distribution with N radiation sources,
$$f ( x , y ) = {\sum }_{i = 1}^{N} \frac{{A}_{i}}{\sqrt{[ {( x - {x}_{i} )}^{2} + {( y - {y}_{i} )}^{2} ]}}$$
where N denotes a number, Aᵢ denotes the amplitude of the ith source, (xᵢ, yᵢ) denotes the coordinates of the center of source i.

11. The DRM generation system of claim 1, wherein:
said monitor is a Radiation Boundary Monitors (RBM) for real-time display.

12. A method for Dense Radiation Map (DRM) generation comprising the steps of:
a. distributing radiation detectors to collect signals of radiation levels in a facility;
b. connecting said radiation detectors to a wireless sensor network;
c. transmitting said radiation levels signals wirelessly to a central data processing center for storage and processing through said wireless sensor network;
d. calculating said collected radiation data using an algorithm;
e. estimating parameters in a model based on said calculation;
f. generating said dense radiation map using results of said estimated parameters;
g. displaying said dense radiation map in real-time.

13. The method for DRM generation of claim 12, wherein:
said algorithm is a parametrized model which characterizes the radiation distribution.

14. The method for DRM generation of claim 13, wherein:
for a Gaussian distribution with N radiation sources,
said algorithm is using the following equation:
$$f ( x , y ) = {\sum }_{i = 1}^{N} {A}_{i} {e}^{- [ {( x - {x}_{i} )}^{2} + {( y - {y}_{i} )}^{2} ] / 2 {σ}_{i}^{2}}$$
where N denotes a number, Aᵢ denotes the amplitude of the i^{th} source, (xᵢ, yᵢ) denotes the coordinates of the center of source i, σᵢ denotes the standard deviation of source i.

15. The method for DRM generation of claim 13, wherein:
for an inverse distribution with N radiation sources,
said algorithm is using the following equation:
$$f ( x , y ) = {\sum }_{i = 1}^{N} \frac{{A}_{i}}{\sqrt{[ {( x - {x}_{i} )}^{2} + {( y - {y}_{i} )}^{2} ]}}$$
where N denotes a number, Aᵢ denotes the amplitude of the i^{th} source, (xᵢ, yᵢ) denotes the coordinates of the center of source i, σᵢ denotes the standard deviation of source i.

16. The method for DRM generation of claim 14, wherein:
said algorithm is for a Gaussian distribution with numerous radiation sources.

17. The method for DRM generation of claim 15, wherein:
said algorithm is for an inverse distribution with numerous radiation sources.
